(19) United States
(12) Patent Application Publication
(10) Pub. No.: US 2017/0322736 A1
(43) Pub. Date: Nov. 9, 2017

(54) REORDER ACTIVE PAGES TO IMPROVE SWAP PERFORMANCE

(71) Applicant: Qualcomm Innovation Center, Inc., San Diego, CA (US)

(72) Inventors: William Kimberly, San Diego, CA (US); Venkatakrishnan Gopalakrishnan, San Diego, CA (US); Ajay Iyengar, San Diego, CA (US)

(21) Appl. No.: 15/149,930

(22) Filed: May 9, 2016

(51) Int. Cl. G06F 3/06; G06F 12/1009

(52) U.S. Cl. CPC G06F 3/065; G06F 12/1009; G06F 3/0679; G06F 3/0685; G06F 3/0619; G06F 2212/1032; G06F 2212/2022; G06F 2212/7201

(57) ABSTRACT

A method and device for using volatile and non-volatile computer memory are provided. The method may comprise locating page table entries associated with a plurality of pages associated with a process in a first data structure in the volatile memory, the process having a low likelihood of execution in comparison to other processes. Then, the method may comprise copying the plurality of pages to a second data structure in the volatile memory. Next, the method may further comprise copying the plurality of pages from the second data structure to a third data structure in the volatile memory at the same time. Finally, the method may include writing the plurality of pages from the third data structure to contiguous blocks of non-volatile memory based on the plurality of pages having been written to the third data structure at the same time.

### FIELD OF THE DISCLOSURE

The present invention relates to memory performance in computer operating systems. In particular, but not by way of limitation, the present invention relates to reordering data placement in swap storage in Linux operating systems.

### BACKGROUND

In computer operating systems, active computer programs typically utilize volatile memory known as random access memory, or RAM. When a user uses many programs, or a particular program requires a high amount of RAM, various methods are utilized to free up more available RAM. One of these methods includes temporarily offloading data from RAM to an area in non-volatile storage that is typically known as “swap.” The particular data that gets offloaded to swap in non-volatile storage at any given time is usually data that is not actively needed by a running program at that particular time. When the data that is offloaded is needed again by a running program, the data is loaded from swap in non-volatile storage back into RAM.

Many operating systems use flash-based non-volatile storage media, which are also known as solid state drives. While flash storage provides many performance benefits over hard disk drive storage, these performance benefits are most useful when the flash storage is used for large, sequential accesses. However, some operating systems, such as Linux, use a Memory Management subsystem that tends to result in small, random accesses from RAM to swap. As a result, the methods used to access data from swap in Linux systems with flash storage can be slow and may become even slower over time. Therefore, a need exists for ways to optimize accesses from RAM to swap to improve overall performance.

### SUMMARY

One aspect of the disclosure provides a method for using volatile and non-volatile computer memory. The method may comprise locating page table entries associated with a plurality of pages associated with a process in a first data structure in the volatile memory, the process having a low likelihood of execution in comparison to other processes. Then, the method may comprise copying the plurality of pages to a second data structure in the volatile memory. Next, the method may further comprise copying the plurality of pages from the second data structure to a third data structure in the volatile memory at the same time. Finally, the method may include writing the plurality of pages from the third data structure to contiguous blocks of non-volatile memory based on the plurality of pages having been written to the third data structure at the same time.

Another aspect of the disclosure provides a computing device comprising a processor configured to execute a memory management subsystem and a memory comprising volatile and non-volatile memory. The processor and memory may be configured to first locate page table entries associated with a plurality of pages associated with a process in a first data structure in the volatile memory, the process having a low likelihood of execution in comparison to other processes. The processor and memory may be further configured to copy the plurality of pages to a second data structure in the volatile memory, and then to copy the plurality of pages from the second data structure to a third data structure in the physical volatile memory at the same time. The processor and memory may also be configured to then write the plurality of pages from the third data structure to contiguous blocks of non-volatile memory based on the plurality of pages having been written to the third data structure at the same time.

Yet another aspect of the disclosure provides a non-transitory, tangible computer readable storage medium, encoded with processor readable instructions to perform a method for using volatile and non-volatile computer memory. The method may comprise locating page table entries associated with a plurality of pages associated with a process in a first data structure in the volatile memory, the process having a low likelihood of execution in comparison to other processes. Then, the method may comprise copying the plurality of pages to a second data structure in the volatile memory. Next, the method may further comprise copying the plurality of pages from the second data structure to a third data structure in the volatile memory at the same time. Finally, the method may include writing the plurality of pages from the third data structure to contiguous blocks of non-volatile memory based on the plurality of pages having been written to the third data structure at the same time.

### BRIEF DESCRIPTION OF THE DRAWINGS

FIG. 1 shows how virtual memory may be used to map virtual memory addresses to physical memory addresses in volatile and non-volatile memory.

FIG. 2 illustrates data structures in volatile memory that are used to manage memory access in operating systems.

FIG. 3 illustrates an aspect of the present disclosure in which the locations of pages belonging to a process are identified by analyzing a page table.

FIG. 4 illustrates an aspect of the disclosure in which pages belonging to the same process are removed from a first list and placed together on a second list.

FIG. 5 illustrates an aspect of the disclosure in which the pages placed on the second list are temporarily stored on the second list.

FIG. 6 illustrates an aspect of the disclosure in which the pages belonging to the same process that were temporarily stored on the second list are added to a third list in volatile memory all at once.

FIG. 7 is a logical block diagram of components of a computing device which may implement aspects of the present disclosure.

FIG. 8 is a logical block diagram of another embodiment of a computing device which may implement aspects of the present disclosure.

FIG. 9 is a flowchart which may be traversed to depict a method for memory management in accordance with the present disclosure.

### DETAILED DESCRIPTION

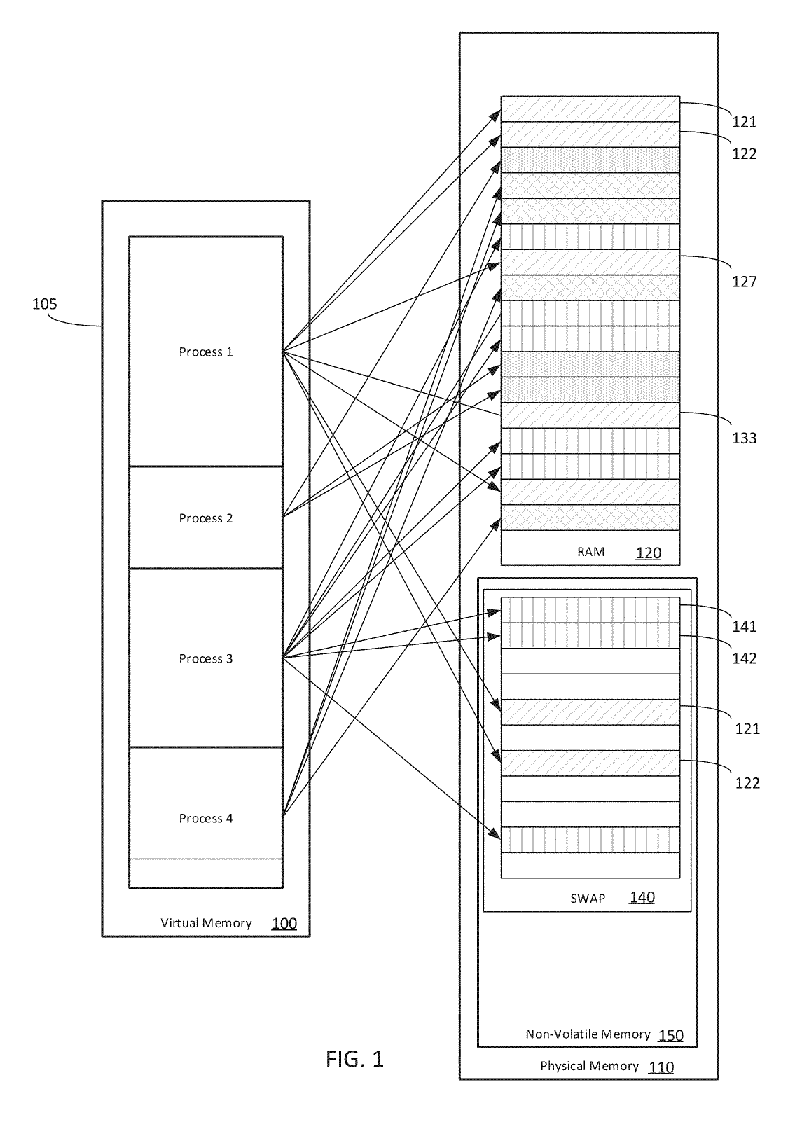

In kernels of operating systems such as Linux, memory management subsystems utilize virtual memory, which is a memory management technique known in the art that maps physical addresses in computer memory to virtual addresses. Virtual memory allows a particular process to operate as if its data were located in physical memory as one contiguous address space, even though the data may actually be located in non-contiguous physical address spaces. Virtual memory works in part by dividing up data from processes into same-size blocks known as pages, and by using a page table that maps virtual addresses to physical addresses. A common page size used for blocks of data in Linux and other operating systems is 4 KB, though other page sizes may be used without departing from the present disclosure. FIG. 1 shows how in a virtual memory 100, data from various processes can have virtual addresses that are sequential and contiguous, though their addresses in physical memory 110 are not sequential and not contiguous. For example, in FIG. 1, Process 1 has one contiguous virtual address space 105, but its data is divided up into several pages 121, 122, 127, and 133 which have corresponding physical addresses in RAM 120 that are located in non-contiguous spaces. Throughout this disclosure, the terms “sequential spaces” “sequential blocks,” “contiguous spaces,” and “contiguous blocks” may be used interchangeably and refer to physical, readable and writeable memory blocks that are located next to each other with no other blocks in between.

FIG. 1 also illustrates that some processes have pages of data that have physical addresses in a swap storage location 140 (“swap”) located in a non-volatile memory 150. Various reasons for why certain pages may be temporarily stored in swap 140 will be discussed later in the disclosure. As shown, Process 3 has pages 141 and 142 stored in swap 140. A page table that maps virtual addresses to physical addresses will be discussed throughout the disclosure. Some operating systems direct pages that are written to swap to be stored in either swap “partitions” or swap “files;” aspects of the present disclosure may apply to either type of swap storage.

When an operating system is running many processes, a computing device's RAM may run out of physical space to store process data. For example, if an operating system user opens many programs, or opens a few programs that run processes requiring a high amount of RAM, eventually, the RAM may become full. When the RAM becomes full, but space is still needed, a memory management subsystem may transfer certain pages from the RAM to temporarily store them in swap. It is more inefficient for a process to retrieve data from swap than to retrieve it from RAM, because of the properties of commonly used non-volatile memory (i.e., hard disk drives and flash storage). However, utilizing swap as a sort of “last resort” type of storage is better than not having needed data stored at all. The alternative to having data stored in swap would be to completely kill a process. Typically, a memory management subsystem implements an algorithm to determine which pages get transferred to swap, which involves determining which pages are least likely to be used again in the near future, or at all. Various methods may be used to determine which pages are least likely to be used, including lists and algorithms that detect how long a page has gone without being “touched.” Throughout this disclosure, a page may be referred to as being touched whenever it is actively used for process execution by a central processing unit (CPU), such as by being read from memory or written to memory.

Operating systems typically use several lists to manage processes and their pages that are allocated to memory. In Linux, for example, three types of lists are typically used. These include “file system cache data lists,” which include two subtypes known as “active file list” and “inactive file list.” Another type of list is known as “unevictable,” which contains allocated memory that cannot be moved to swap. The third type of list are “anonymous” lists, which have two subtypes known as “active anonymous” and “inactive anonymous.” In Linux, the pages that may ultimately be moved to swap are managed using these two lists—Active Anonymous and Inactive Anonymous. These lists are called “anonymous” because the system does not necessarily know which process the pages belong to without referring to a page table. Aspects of a page table will be described throughout the disclosure. Though the present disclosure refers to the specifically named data structures called the “Active Anonymous list” and the “Inactive Anonymous list” which are their names in Linux, aspects of the disclosure may also apply to the operating systems, data structures, and/or lists that function similarly, even if they are known by other names in other operating systems. A list is one of several types of data structures used to physically allocate and organize memory.

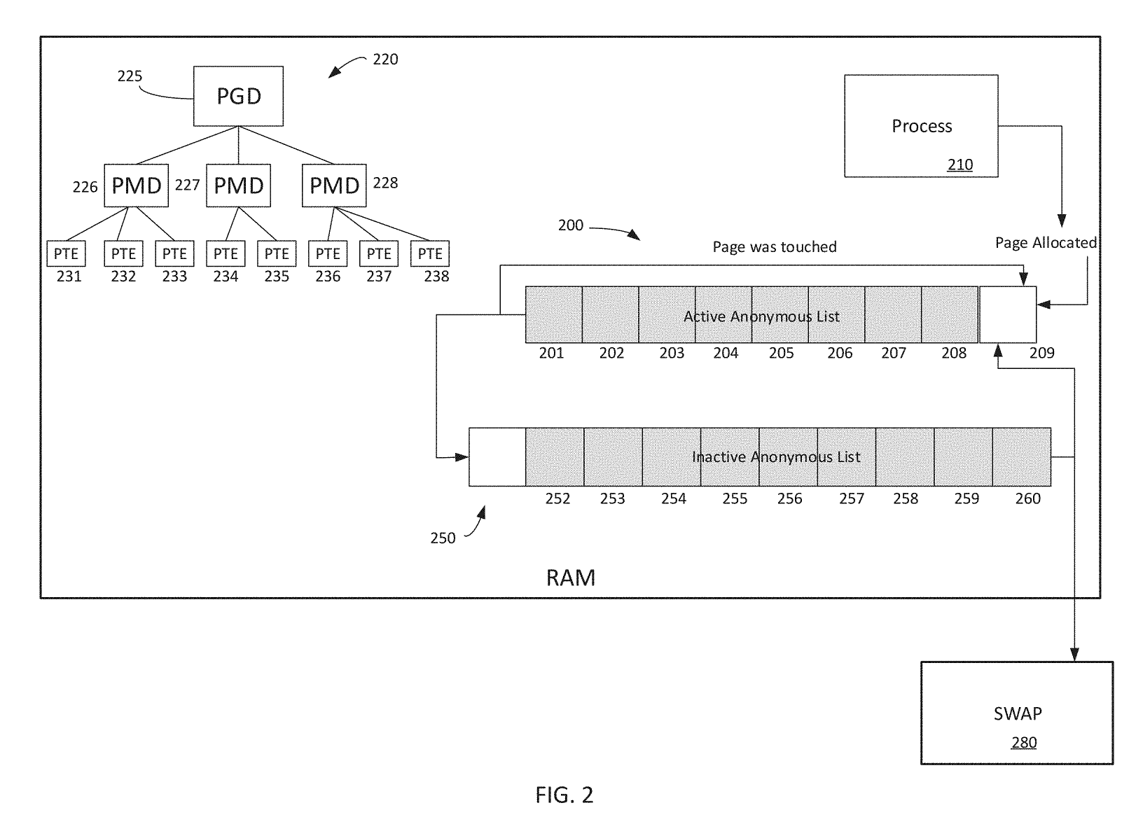

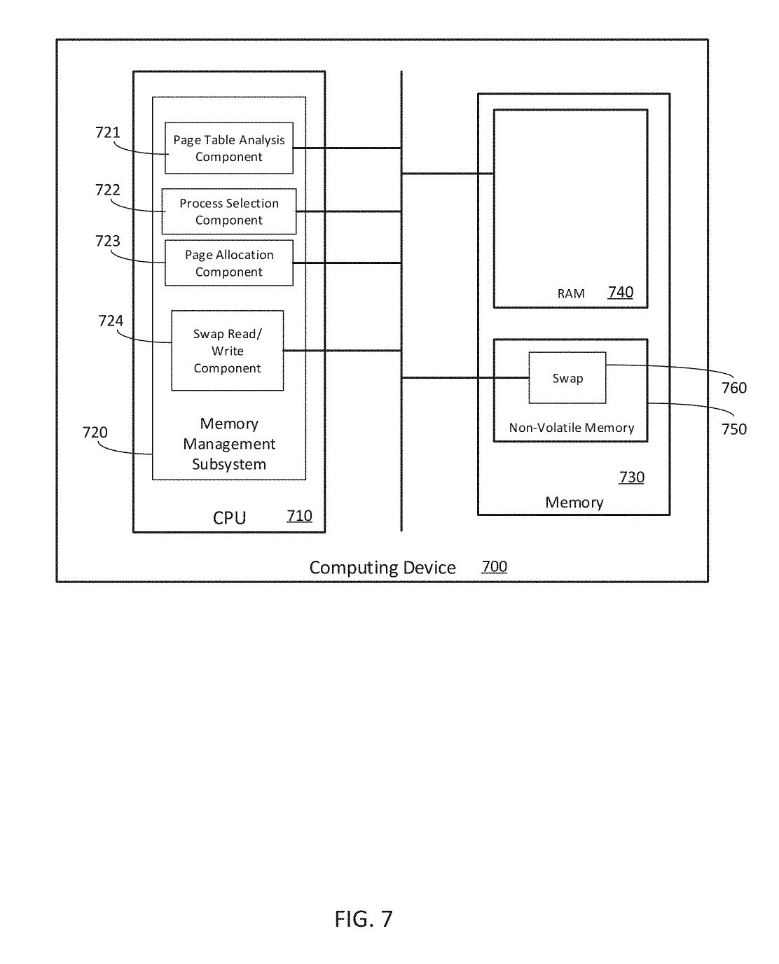

Turning briefly to FIG. 7, shown is a logical block diagram depicting components that may be used to implement aspects of the present disclosure. Throughout the descriptions accompanying FIGS. 2-6 and 8-9, simultaneous reference may be made to the components described in FIG. 7. FIG. 7 is not intended to be a hardware diagram; rather, it represents logical blocks that may be implemented in hardware alone, a combination of hardware and software, or software alone. As shown, a computing device 700 may comprise a CPU 710. The CPU 710 may execute a memory management subsystem 720, which may itself comprise a page table analysis component 721, a process selection component 722, a page allocation component 723, and a swap read/write component 724. The computing device may also comprise a system memory 730, which itself may comprise RAM (volatile memory) 740 and non-volatile memory 750. The non-volatile memory may itself comprise swap 760. Aspects of the various components in FIG. 7 will be describer in further detail throughout the disclosure.

Turning back to FIG. 2, shown are how pages are typically managed by an Active Anonymous list 200, an Inactive Anonymous list 250, and a page table 220 in Linux. Each of these data structures may exist in RAM 760. An Active Anonymous list 200 contains active pages 201-208. Each of the pages 201-208 may be mapped to its virtual address, and to its process, by a page table 220, which contains a page table entry for each page in memory. Each page may have been allocated from one or more processes 210. The page table 220 may also exist in RAM 760. In the page table 220, each of the page table entries 231-238 correspond to the pages 201-208 in the Active Anonymous list 200. The page table entries 231-238 have access to various information about each page 201-208, including their physical addresses in memory, flags (which indicate to which list the page belongs and whether it is active or inactive), virtual addresses, or swap locations, among other things. When the Linux memory management subsystem needs to find the information for a particular page, it may do so by “walking the page table,” of a process, which means it may look first to the page global directory 225, then the page middle directory 226, 227, and 228, and then to each individual page table entry. The method of discovering the information in a page table entry may also be referred to as “analyzing” the page table, and may be implemented by, for example, the page table analysis component 721. The page table 220 in FIG. 2 is depicted in a simplified form to illustrate the relationship between individual page table entries 231-238 and individual pages 201-208.

Though the memory management subsystem may walk the page table for a particular process for various other reasons, it is not typically walked for the purposes of managing the Active Anonymous list 200 and the Inactive Anonymous List 250. Pages are placed in the Active Anonymous list when dynamic memory is allocated or recently accessed. A blank space 209 may represent a 4KB block of memory that is available for the allocation of a 4KB page. Because it is not necessarily known to which process a page belongs on these anonymous lists, pages belonging to the same process may not be physically allocated next to each other on the Active Anonymous list 200. That is, pages of various processes may be interspersed on the physical memory space used for the Active Anonymous list 200. When any page is allocated to Active Anonymous list, a flag is set to indicate that the page has not been accessed. If the page is later accessed by a process the same flag will be set to indicate the page was accessed. The lists will be scanned when the amount of memory available is low. The page inserted into the Active Anonymous list 200 will remain on the list as long as the accessed flag is set when the list is processed for low memory. If the flag is set to indicate it has not been accessed for a page in the

Active list when the list is processed, the page is moved from the Active Anonymous list to the Inactive Anonymous list 250. The movement of a page from the Active Anonymous list 200 to the Inactive Anonymous list may be visualized as the pages moving from right to left (i.e., from block 209 to the location of page 201), with the most recently active page being on the right (209) and least recently active (201) being on the left. Though this visualization is conceptually helpful, it should be appreciated that physical memory blocks are not necessarily ordered in a linear fashion according to how recently it was allocated, nor do they move linearly from one block of physical memory to another. For example, a page may be touched at any time while it is on the Active Anonymous list 220, at which time its accessed flag may be reset, when processing the Active Anonymous list 220, this page would be moved from the end of the list to the beginning.

As noted earlier, the pages 201-208 that are located next to each other may not belong to the same process. Because the pages are not in order according to their processes while on the Active Anonymous list 200, when they are moved to the Inactive Anonymous list 250, they are also not in order according to their processes. A page may be touched at any time while it is on the Inactive Anonymous list 250 and moved back to the Active Anonymous list 200. However, it is less likely, in general, that a page that is on the Inactive Anonymous list 250 will be touched than a page on the Active Anonymous list 200, simply due to the fact that the longer a page has not been needed, the less likely it will be needed again soon. While pages are in either the Active Anonymous list 200 or the Inactive Anonymous list 250, it is of little consequence that the pages are not located in contiguous physical space in RAM, because the pages may be quickly found through the page table 220 and accessed from either list by the process when they are in RAM.

Once a page has been on the Inactive Anonymous list 250 for a certain period, it will get written to swap 280 in non-volatile memory (also depicted in FIG. 7 as swap 760 in non-volatile memory 750). The page moves through the Inactive Anonymous list 250 and then to swap 280, which may be visualized as moving from left to right, in a similar manner as the visualization of the Active Anonymous list 200. In general, inactive pages 252-260 will get written into swap in the order they moved into the Inactive Anonymous list, unless a page gets touched while on the Inactive Anonymous list 250. If a page gets touched while on the Inactive Anonymous list 250, it may be moved to the beginning of the Active Anonymous list 200. As noted earlier, pages in the Inactive Anonymous list 250 are often not grouped by their processes. Therefore, when they get written to swap 280, the pages belonging to the same process are often written to non-contiguous physical memory space in swap.

Having pages belonging to the same process written to non-contiguous address space in swap can cause user-perceptible delays in accessing data for a process. When a page is needed by a process, the memory management subsystem quickly indexes into the page tables to see where the page is located in physical memory. This step may also be implemented by the page table analysis component 721. If the page is not in RAM, a “page miss” occurs, and the memory management subsystem 710 directs the CPU to locate the page in swap, utilizing, for example, the swap read/write component 724 to transfer the pages back to RAM (e.g., RAM 740). Reading pages out of non-volatile memory is slower than reading it out of RAM, regardless of whether the non-volatile memory is a hard disk drive or flash storage. In computing devices with hard disk drives, users can often hear the drives moving when they are being read from, which often corresponds with a delay in an aspect of a program visible on a user interface. Computing devices with flash storage perform such reads from swap faster, and more and more computing devices utilize flash storage to take advantage of such performance benefits. However, flash storage itself is much faster at making large reads from sequential physical memory locations than from small, non-sequential memory locations. Therefore, even in devices using flash storage, it can be problematic that pages written to swap are written out of order in relation to their processes. The algorithms that the Linux memory management subsystem uses for determining which pages get moved to the Active Anonymous list, and subsequently to the Inactive Anonymous list, and then swap, results in pages of processes not being located next to each other. Although these algorithms provide memory management benefits while the pages remain in RAM, the non-sequential page writes to swap create a disadvantage when the pages need to be read out of swap. Reads out of swap are slower when they are from non-contiguous physical spaces in the first place. Additionally, it is known in the art that fragmentation occurs with virtual memory systems, so over time, as non-volatile memory becomes more fragmented and pages of the same process get written even farther apart, reads become even slower.

An aspect of the present disclosure is to improve the spatial locality of pages of the same processes that are written to swap. When pages of a process in swap are located next to each other, reads out of swap become faster, which reduces the latency of retrieving data needed for processes, and therefore reduces the time that users have to wait for programs to perform as expected.

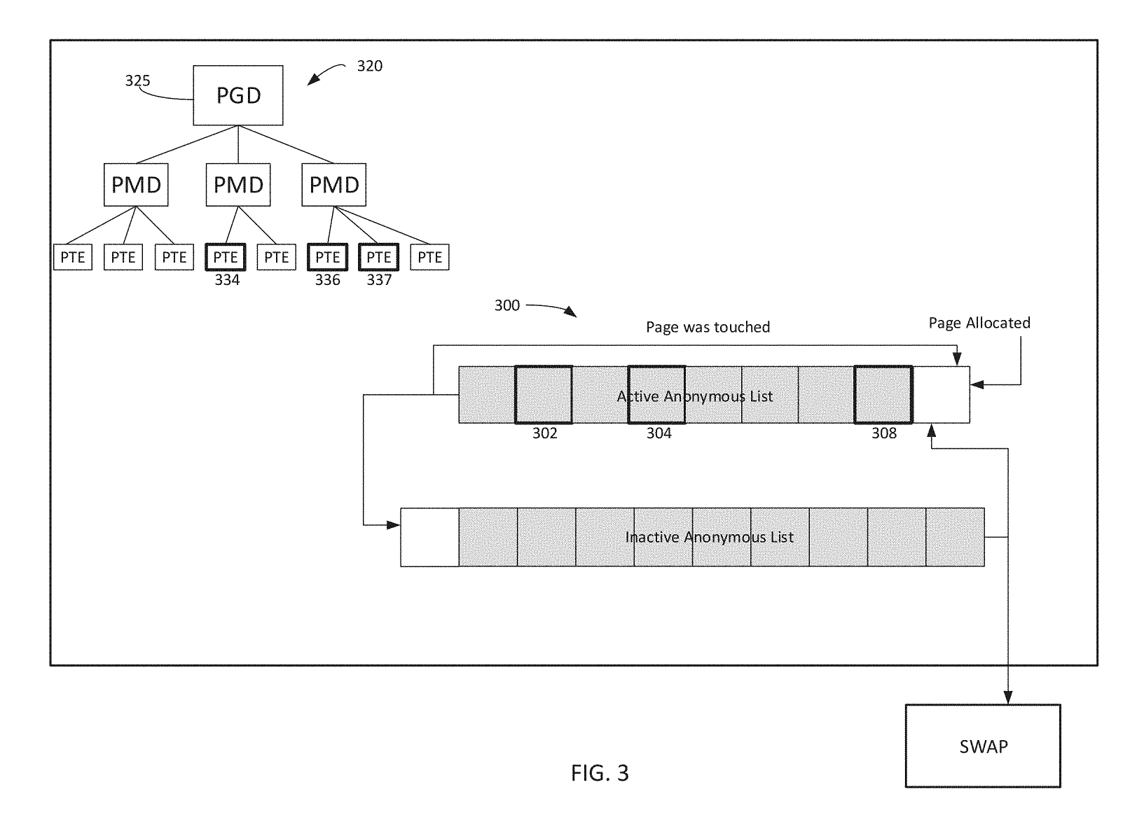

An aspect of the present disclosure is directed toward increasing the spatial locality of the pages belonging to a process when those pages get written to swap, or in other words, writing more pages of the same process to contiguous blocks of physical memory in swap than they would otherwise. FIG. 3 illustrates some steps of a method that may be used according to the present disclosure. First, the memory management system may select a process that, as a whole, has a low likelihood of running again in the near future, or at all. This may be ascertained by the CPU—and particularly by the process selection component 722—by a variety of methods, including using out-of-memory (OOM) scores. OOM scores (sometimes referred to as OOM_adj_score) are known in the art as numerical values that may be assigned to programs, processes, or pages to rank them by likelihood of being used or needed again. For example, a process or page may have its OOM score adjusted higher and higher the longer it has gone without being used. It is contemplated that if an entire process has a high OOM score, it may have many pages already allocated to the Active Anonymous list.

Next, the memory management subsystem 720 may walk the page table 320 to find pages of the selected process that are located on the Active Anonymous list 300. As shown, the page table entries 334, 336, and 337 are highlighted to show that they are part of the same process. The PTEs 334, 336, and 337 provide physical addresses to show where they are located in the Active Anonymous list 300. The pages corresponding to the PTEs 334, 336, 337 are pages 302, 304, and 308, also highlighted in the Active Anonymous list 300.

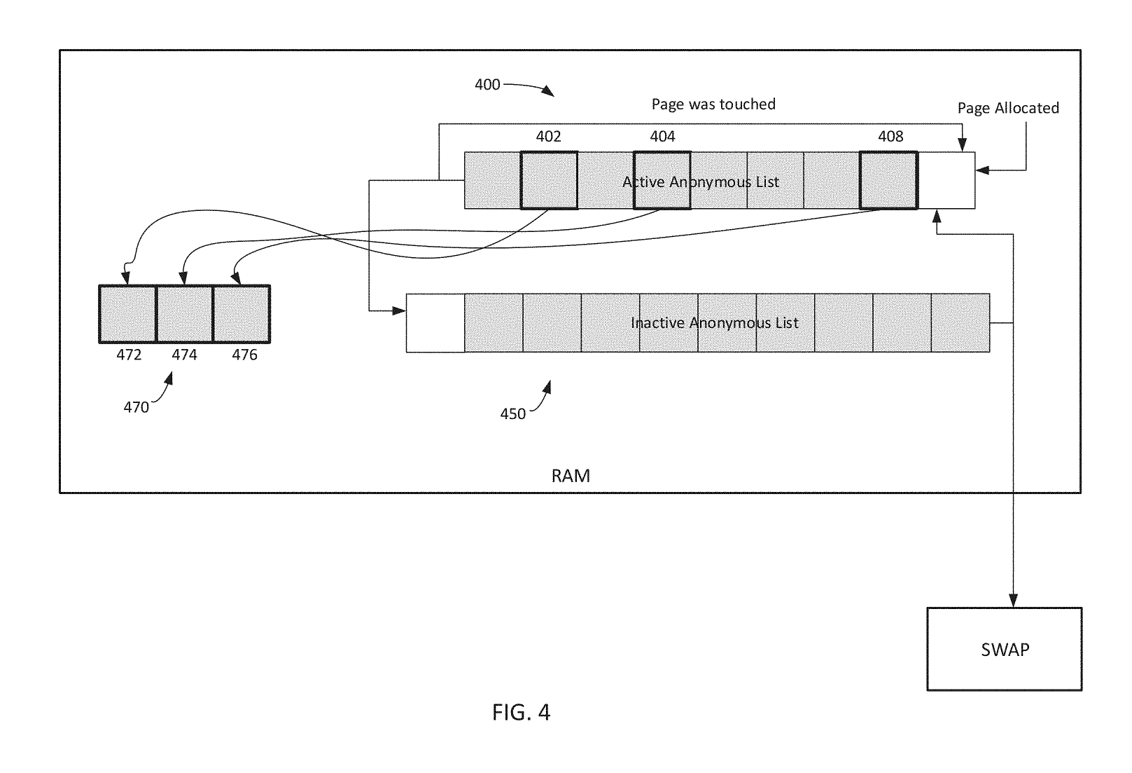

An aspect of the present disclosure is that a new data structure may be created to facilitate the method of increasing spatial locality of pages written to swap. FIG. 4 shows the new data structure, which is an Inactive Process Anonymous list 470. Once the pages of the same process from the Active Anonymous list 400 have been located (depicted in FIG. 4 as pages 402, 404, and 408), they may be copied (i.e., placed or transferred) in the Inactive Process Anonymous list 470 by the page allocation component 723. As shown, the pages 402, 404, and 408, once transferred, are represented as pages 472, 474, and 478.

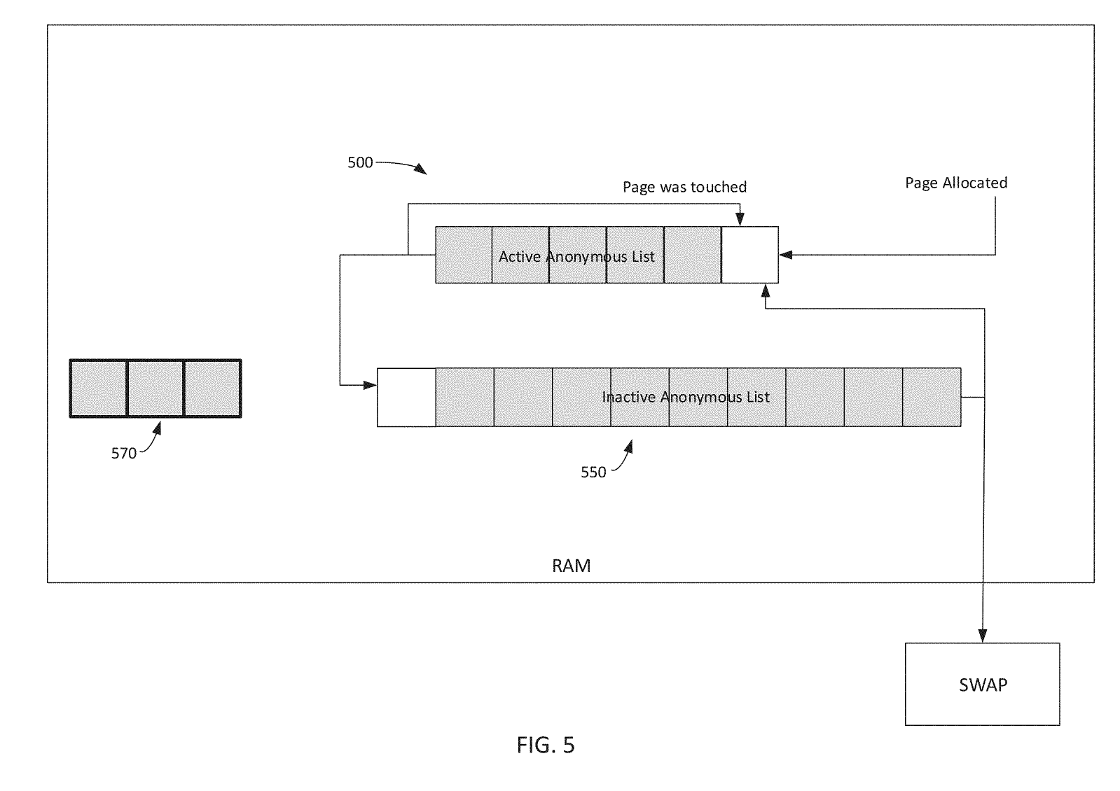

Turning now to FIG. 5, shown are the three lists, Active Anonymous 500, Inactive Process Anonymous 570, and Inactive Anonymous 550. FIG. 5 is similar to FIG. 4, except that the Active Anonymous list is shown with the three pages belonging to the same process (402, 404, and 408 from FIG. 4) removed from the Active Anonymous list 500 completely. Pages may remain on the Inactive Process Anonymous list 570 for a certain period of time in order to wait for other aspects of the method to be implemented. For example, the pages may remain on the Inactive Process Anonymous list 570 long enough to allow all the pages from a particular process to be allocated to the list.

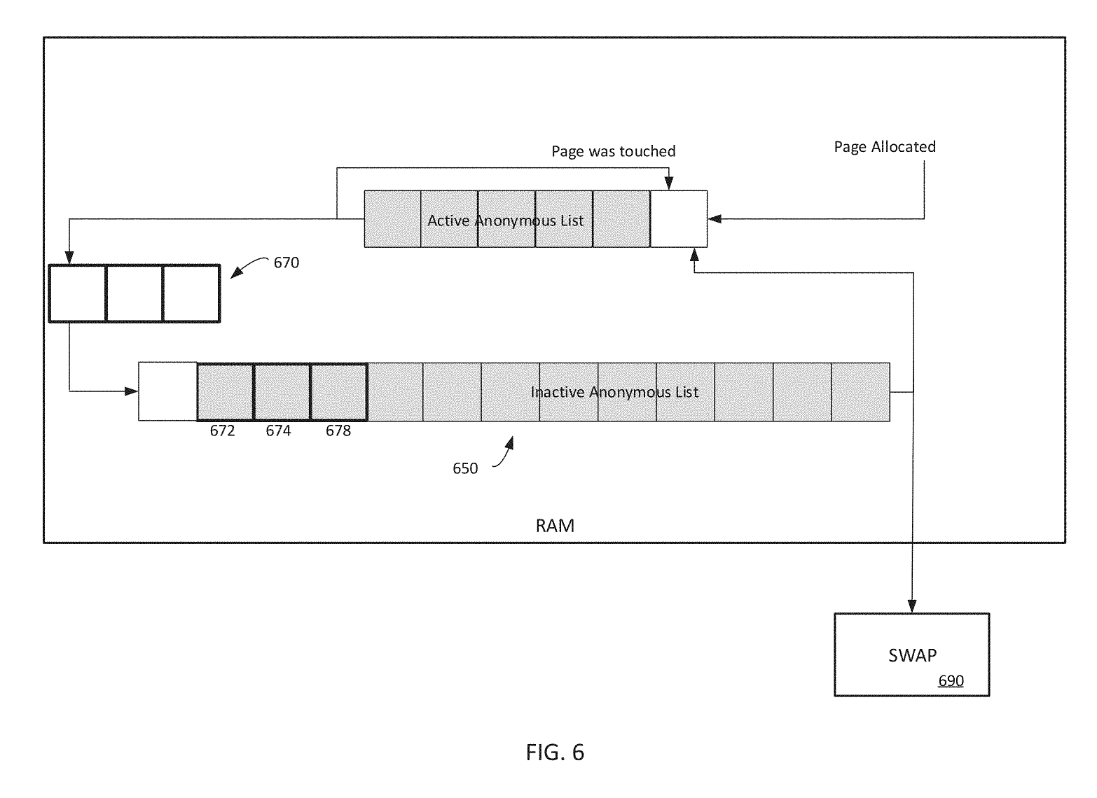

Next, as shown in FIG. 6, the pages from the Inactive Process Anonymous list 670 may be copied or moved to the “end” of the Inactive Anonymous list 650. This step may be implemented by the page allocation component 723. The pages 672, 674, and 678, which were formerly on the Inactive Anonymous Process List 670 will be copied or moved to the Inactive Anonymous list 650 all at once. That is, they may be copied all at the same time. If the pages 672, 674 and 678 are not touched while on the Inactive Anonymous List 650, they may subsequently be written to swap 690 in a contiguous block of non-volatile memory. These pages may be written to swap 690 in a contiguous block of non-volatile memory because they were transferred to the Inactive Anonymous List 650 at the same time.

In some embodiments of the present disclosure, the memory management subsystem 720 may walk the page table for a process to find pages of the selected process that are in the Active Anonymous list and move those pages to the Inactive Process Anonymous list. These steps may be continued until all of the pages of the selected process are located and placed on the Inactive Process Anonymous list, or until a predetermined number of pages are located and placed, or until a predetermined period of time has elapsed. It is contemplated that at a given point in time, not all of the pages of a particular process may be on the Active Anonymous list. However, since some pages are on the Active Anonymous list, it is likely that more pages may end up on that list soon, given that pages on the Active Anonymous list are there because there is some indication that the pages may become inactive soon.

In some embodiments, all the pages of a particular selected process may be placed on the Inactive Anonymous list at the same time, and subsequently, all the pages of that process may be written to contiguous physical address space in non-volatile memory. In other embodiments, just a portion of the pages of the process may be written to swap together. It is contemplated that if a process has been inactive for a long enough time to get written to swap, if it needs to be read from swap, it is likely that the entire process will be needed. Therefore, having all the pages in contiguous block is highly advantageous. For example, a single process may comprise 80 KB of data, which is divided up into twenty 4 KB pages. For both flash storage and hard disk drives, one read of 80 KB is much faster than twenty reads of 4 KB. Even if the entire process is not written in one contiguous block in swap, but if the spatial locality is improved to some extent by the methods of the present disclosure, reads may still be significantly faster than with prior methods. For example, if 40 KB of the process was written to ten contiguous blocks, 20 KB was written to another five contiguous blocks, and 20KB was written to another five contiguous blocks, the three reads would be much faster than twenty reads of 4 KB.

It is contemplated that the improvement in speed of reading pages from swap may be perceptible to a user over prior methods. Additionally, it is contemplated that certain system performance improvements may be achieved due to the fact that the writing of pages to contiguous areas of swap takes place all at once. These performance improvements may include utilizing fewer processor resources and memory bandwidth. However, the improvements may not necessarily be perceptible to a user.

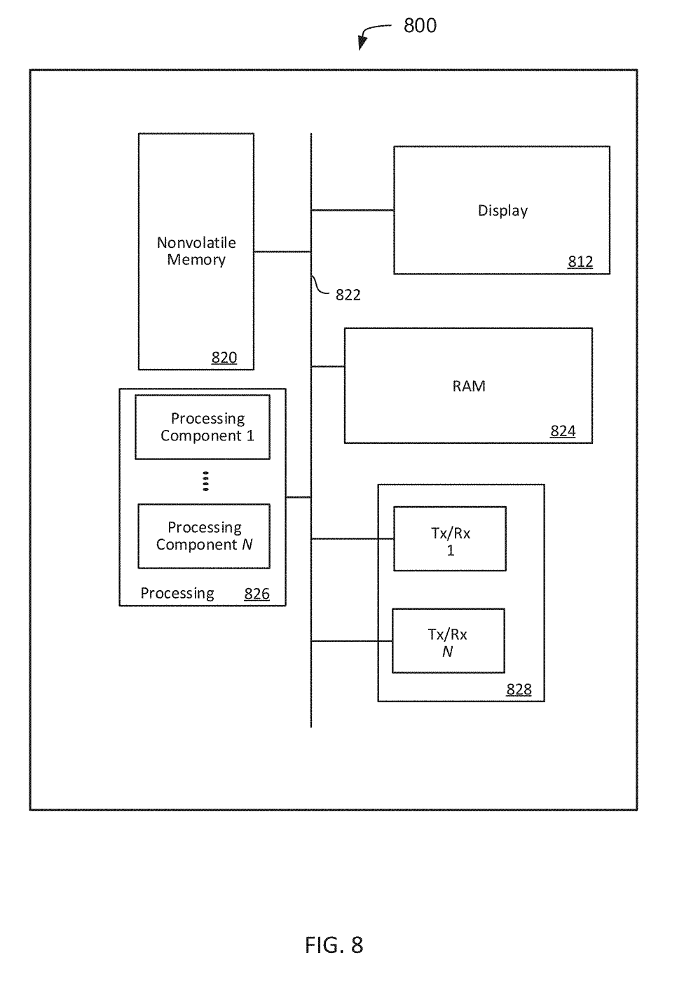

Referring next to FIG. 8, shown is a block diagram depicting high-level physical components of an exemplary computing device 800 that may be utilized to realize a computing device of the present disclosure. As shown, the computing device 800 in this embodiment includes a display portion 812, and nonvolatile memory 820 (similar to non-volatile memory 750 of FIG. 7) that are coupled to a bus 822 that is also coupled to random access memory (“RAM”) 824 (similar to RAM 740 of FIG. 7), and a processing portion (which includes N processing components) 826. The processing portion 826 may correspond to the CPU 710 of FIG. 7. Although the components depicted in FIG. 8 represent physical components, FIG. 8 is not intended to be a hardware diagram; thus many of the components depicted in FIG. 8 may be realized by common constructs or distributed among additional physical components. Moreover, it is certainly contemplated that other existing and yet-to-be developed physical components and architectures may be utilized to implement the functional components described with reference to FIG. 8.

This display portion 812 generally operates to provide a presentation of content to a user. In several implementations, the display is realized by an LCD or OLED display. In general, the nonvolatile memory 820 functions to store (e.g., persistently store) data and executable code including code that is associated with the functional components described herein, in addition to other functions and aspects of the nonvolatile memory unique to the present disclosure. In some embodiments for example, the nonvolatile memory 820 includes bootloader code, modem software, operating system code, file system code, and code to facilitate the implementation of one or more portions of the memory management subsystem 720.

In many implementations, the nonvolatile memory 820 is realized by flash memory as described throughout the disclosure (e.g., NAND or ONENAND™ memory), but it is certainly contemplated that other memory types may be utilized as well, such as traditional hard disk drives. Although it may be possible to execute the code from the nonvolatile memory 820, (e.g., via the swap read/write functionality described herein) the executable code in the nonvolatile memory 820 is typically loaded into RAM 824 and executed by one or more of the N processing components in the processing portion 826. In many embodiments, the system memory may be implemented through the nonvolatile memory 820, the RAM 824, or some combination thereof.

The N processing components in connection with RAM 824 generally operate to execute the instructions stored in nonvolatile memory 820 to effectuate the functional components described herein. As one of ordinarily skill in the art will appreciate, the processing portion 826 may include a video processor, modem processor, DSP, and other processing components.

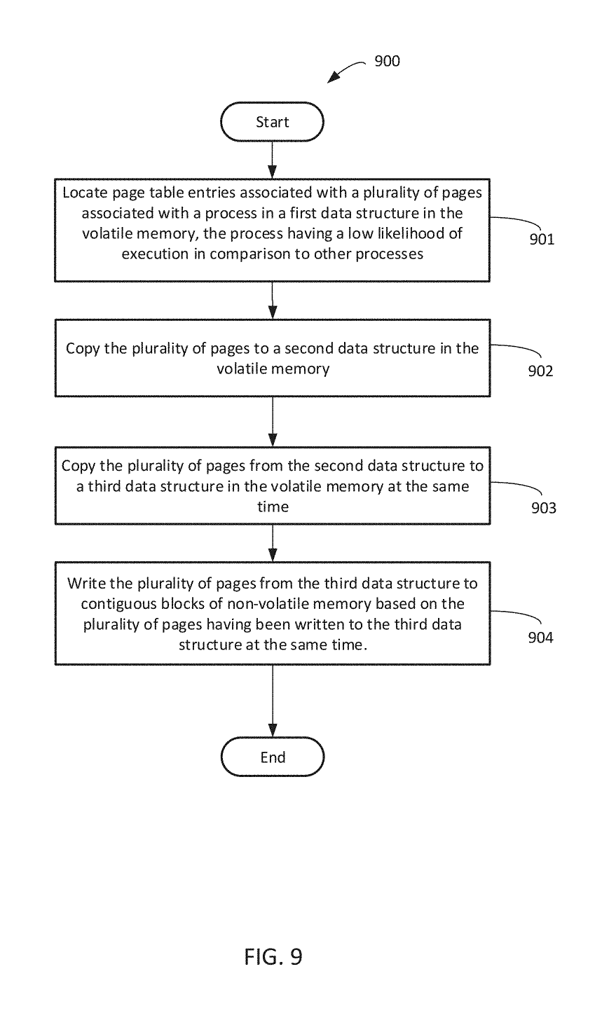

FIG. 9 is a flowchart which may be traversed to depict a method 900 in accordance with embodiments of the disclosure. The method may first include, at Block 901, locating page table entries associated with a plurality of pages associated with a process in a first data structure in the volatile memory, the process having a low likelihood of execution in comparison to other processes. The process may be selected by the process selection component 722, the location of page table entries may be implemented by the page table analysis component 721, and the physical volatile memory may be implemented by RAM 740. Next, the method may comprise, at Block 902, copying the plurality of pages to a second data structure in the volatile memory. The copying may be implemented by the page allocation component 723. Then, at Block 903, the method may comprise copying the plurality of pages from the second data structure to a third data structure in the volatile memory at the same time. The copying from the second data structure to the third data structure may be implemented by the page allocation component 723 as well. Then, at Block 904, the method may comprise writing the plurality of pages from the third data structure to contiguous blocks of non-volatile memory based on the plurality of pages having been written to the third data structure at the same time. The writing may be implemented by the swap read/write component 724, and the non-volatile memory may be implemented by the non-volatile memory 750.

In conclusion, embodiments of the present invention improve user experience by reducing latency and/or power consumption associated with reads from and writes to swap. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A method for using volatile and non-volatile computer memory, the method comprising:
locating page table entries associated with a plurality of pages associated with a process in a first data structure in the volatile memory, the process having a low likelihood of execution in comparison to other processes,
copying the plurality of pages to a second data structure in the volatile memory,
copying the plurality of pages from the second data structure to a third data structure in the volatile memory at the same time, and
writing the plurality of pages from the third data structure to contiguous blocks of non-volatile memory based on the plurality of pages having been written to the third data structure at the same time.

2. The method of claim 1, further comprising:
reading the pages from the non-volatile memory to use in executing the process.

3. The method of claim 1, wherein all pages associated with the process are written to the non-volatile memory.

4. The method of claim 1, wherein the non-volatile memory comprises flash memory.

5. The method of claim 1, wherein the process having a low likelihood of execution is selected by evaluating which process, out of a plurality of processes, has a highest out-of-memory score.

6. The method of claim 1, wherein the locating of page table entries associated with a plurality of pages and the copying of the plurality of pages to a second data structure are repeated until all pages associated with the process are transferred to the second data structure.

7. The method of claim 1, wherein the method is executed in a Linux operating system, and:
the first data structure comprises an Active Anonymous list,
the second data structure comprises an Inactive Process Anonymous list, and
the third data structure comprises an Inactive Anonymous List.

8. A computing device comprising:
a processor configured to execute a memory management subsystem; and
a memory comprising volatile and non-volatile memory, the processor and memory being configured to:
locate page table entries associated with a plurality of pages associated with a process in a first data structure in the volatile memory, the process having a low likelihood of execution in comparison to other processes,
copy the plurality of pages to a second data structure in the volatile memory,
copy the plurality of pages from the second data structure to a third data structure in the volatile memory at the same time, and
write the plurality of pages from the third data structure to contiguous blocks of non-volatile memory based on the plurality of pages having been written to the third data structure at the same time.

9. The computing device of claim 8, wherein the processor and memory are further configured to:
read the pages from the blocks of non-volatile memory to use in executing the process.

10. The computing device of claim 8, wherein all pages associated with the process are written to the non-volatile memory.

11. The computing device of claim 8, wherein the non-volatile memory comprises flash memory.

12. The computing device of claim 8, wherein the process having a low likelihood of execution is selected by evaluating which process, out of a plurality of processes, has a highest out-of-memory score.

13. The computing device of claim 8, wherein the processor is configured to locate the page table entries associated with a plurality of pages and the copy the plurality of pages to a second data structure repeatedly until all pages associated with the process are transferred to the second data structure.

14. The computing device of claim 8, wherein the processor and memory execute a Linux operating system.

15. A non-transitory, tangible computer readable storage medium, encoded with processor readable instructions to perform a method for using volatile and non-volatile computer memory, the method comprising:
locating page table entries associated with a plurality of pages associated with a process in a first data structure in the volatile memory, the process having a low likelihood of execution in comparison to other processes,
copying the plurality of pages to a second data structure in the volatile memory,
copying the plurality of pages from the second data structure to a third data structure in the volatile memory at the same time, and
writing the plurality of pages from the third data structure to contiguous blocks of non-volatile memory based on the plurality of pages having been written to the third data structure at the same time.

16. The non-transitory, tangible computer readable storage medium of claim 15, wherein the method includes:
reading the pages from the non-volatile memory to use in executing a process.

17. The non-transitory, tangible computer readable storage medium of claim 15, wherein all pages associated with the process are written to the non-volatile memory.

18. The non-transitory, tangible computer readable storage medium of claim 15, wherein the non-volatile memory comprises flash memory.

19. The non-transitory, tangible computer readable storage medium of claim 15, wherein the process having a low likelihood of execution is selected by evaluating which process, out of a plurality of processes, has a highest out-of-memory score.

20. The non-transitory, tangible computer readable storage medium of claim 15, wherein the locating of page table entries associated with a plurality of pages and the copying of the plurality of pages to a second data structure are repeated until all pages associated with the process are transferred to the second data structure.
